(19) United States
(12) Patent Application Publication
(10) Pub. No.: US 2010/0182114 A1
(43) Pub. Date: Jul. 22, 2010

(54) METHOD FOR ADJUSTING INDUCTANCE OF CHOKE AND METHOD FOR DESIGNING CHOKE

(75) Inventors: Yi-Min Huang, Hsinchu City (TW); Roger Hsieh, Hsinchu County (TW); Lan-Chin Hsieh, Kaohsiung City (TW); Tsung-Chan Wu, Tainan County (TW)

Correspondence Address: J C PATENTS, 4 VENTURE, SUITE 250, IRVINE, CA, 92618, US

(73) Assignee: Cyntec Co., Ltd., Hsinchu (TW)

(21) Appl. No.: 12/554,332

(22) Filed: Sep. 4, 2009

(30) Foreign Application Priority Data
Jan. 16, 2009 (TW) 98101627

(51) Int. Cl. H01F 27/02

(52) U.S. Cl. 336/83

(57) ABSTRACT

A method for adjusting the inductance of a choke is provided by the present invention. The method includes with an unchanged structure and unchanged dimensions of the core of the choke, changing the kind of the magnetic materials composing the cores so as to adjust the magnetic permeability of the magnetic material. In addition, the present invention also provides a method for designing a choke, the method includes determining the structure of a first choke and a second choke, determining the dimensions of the cores of the chokes, and selecting magnetic materials composing the cores.

### CROSS-REFERENCE TO RELATED APPLICATION

This application claims the priority benefit of Taiwan application serial no. 98101627, filed on Jan. 16, 2009. The entirety of the above-mentioned patent application is hereby incorporated by reference herein and made a part of specification.

### BACKGROUND OF THE INVENTION

1. Field of the Invention

The present invention generally relates to a choke, and more particularly, to a method for adjusting the inductance of a choke and a method for designing a choke.

2. Description of Related Art

The choke is in charge of stabilizing the current in a circuit so as to filter out noise. Similar to a capacitor, a choke is able to store and discharge electric energy in a circuit so as to adjust current stability. However, different from a capacitor which stores electric energy by means of electric field (charges), a choke accomplishes it by means of magnetic field.

Referring to FIG. 1, a conventional choke 100 has a compound core structure Cl and a copper sheet 140. The compound core structure C1 has a through hole C2 and is formed by an I-shape core 110, an H-shape core 120, and a resin pad 130. The I-shape core 110 is transversely disposed on the H-shape core 120, and the resin pad 130 is disposed between the cores 110 and 120. The cores 110 and 120 are respectively fabricated by sintering ferrite powder at over 800° C. wherein the magnetic permeability of the ferrite powder is more than 1000. The copper sheet 140 passes through the through hole C2, and both ends 142 and 144 of the copper sheet 140 are bent towards a direction far away from the resin pad 130 and extend onto a surface 122 of the H-shape core 120 far away from the through hole C2.

When designing the choke 100, the thickness T of the resin pad 130 can be adjusted for modifying the shortest distance D1 between the cores 110 and 120 so as to form a choke with a desired inductance. Table 1 shows relationships between the inductance of the choke 100 and the thickness T corresponding to three materials.

TABLE 1

| | Material | | |
|---|---|---|---|
| | material 1 | material 2 | material 3 |
| Thickness T | Inductance | | |
| 0.06 mm | 212.6 nH | 213.9 nH | 215.6 nH |
| 0.1 mm | 145.1 nH | 145.6 nH | 146.2 nH |
| 0.125 mm | 123.6 nH | 124.0 nH | 124.4 nH |

The results in Table 1 indicate that the inductance varies with the thickness T, and the larger thickness T is, and the smaller inductance is.

It should be noted that the resin pad 130 causes a gap G1 in the compound core structure C1, and the gap G1 would cause abnormal sound during the operation and reduce the inductance of the choke. As a result, the cores 110 and 120 demand a material with higher magnetic permeability (i.e., lower saturation characteristic) to fabricate them, which results in poor saturation characteristic.

Table 2 shows relationships between the inductance of the choke 100 and the magnetic permeability of the magnetic material of the cores 110 and 120 corresponding to three thicknesses T.

TABLE 2

| | Magnetic permeability | | |
|---|---|---|---|
| | 1200 | 1600 | 2200 |
| Thickness T | Inductance | | |
| 0.06 mm | 212.6 nH | 217.3 nH | 220.9 nH |
| 0.1 mm | 145.1 nH | 147.1 nH | 148.6 nH |
| 0.125 mm | 123.6 nH | 124.9 nH | 125.9 nH |

The results in Table 2 can be seen that a variation of the magnetic permeability from 1200 to 2200 results in a variation of the inductance from 2% to 4%. That is to say, with the structure of the choke 100, the inductance thereof can not be adjusted by changing the magnetic permeability of the magnetic material, but can be adjusted by changing the thickness T only.

### SUMMARY OF THE INVENTION

Accordingly, the present invention is directed to a method for adjusting the inductance of a choke which is capable of avoiding producing abnormal sound of a conventional choke and promoting the saturation characteristic of the choke.

The present invention is also directed to a method for designing a choke which is capable of avoiding producing abnormal sound of a conventional choke and promoting the saturation characteristic of the choke.

The present invention provides a method for adjusting the inductance of a choke. The choke includes a core and at least a conductive sheet, wherein the core is an integrated formed structure and has a through hole passing through a first surface and a second surface opposite to the first surface of the core, the conductive sheet has a main-body portion and two end portions respectively extending from both ends of the main-body portion, the main-body portion passes through the through hole and the two end portions respectively extend along the first surface and the second surface to outside of the core. The method for adjusting the inductance includes with an unchanged structure and unchanged dimensions of the core, adjusting the magnetic permeability of the magnetic material composing the core.

The present invention provides a method for designing a choke. The method includes following steps. First, the structure of a first choke and a second choke is determined, wherein the first choke and the second choke have the same structure and each choke has a core. Next, the dimensions of the cores are determined, wherein the cores have the dimensions same as each other. Then, the magnetic materials composing the cores is selected, wherein the core of the first choke uses a first magnetic material with first magnetic permeability, the core of the second choke uses a second magnetic material with second magnetic permeability and the first magnetic permeability is different from the second magnetic permeability.

The present invention provides a choke, which includes a core and at least a conductive sheet. The core herein is an integrated formed structure and has a through hole, wherein the through hole passes through a first surface and a second surface opposite to the first surface of the core. The conductive sheet has a main-body portion and two end portions respectively extending from both ends of the main-body portion,; wherein the main-body portion passes through the through hole and the two end portions respectively extend along the first surface and the second surface to outside of the core.

Based on the described above, in the present invention, since the core is an integrated formed structure, so that the inductance of the choke can be adjusted by the magnetic permeability of the magnetic material composing the core and the present invention can avoid the abnormal sound of the conventional choke produced during operation and promote the saturation characteristic of the choke.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional choke.

FIG. 2A is a schematic view of a choke according to an embodiment of the present invention.

FIG. 2B is an exploded view of the choke in FIG. 2A.

FIG. 3 is a graph showing the relationship between the inductance of the choke in FIG. 2A and the magnetic permeability of the magnetic material composing the core of the choke.

FIG. 4 is a flowchart of a design method of a choke according to an embodiment of the present invention.

FIG. 5 is a graph showing thee saturation characteristics of the choke in FIG. 2A and the choke in FIG. 1 for comparison.

FIG. 6A is a schematic view of a choke according to another embodiment of the present invention.

FIG. 6B is a schematic view of the core of the choke in FIG. 6A.

FIGS. 7A, 7B and 7C are graphs showing the relationships between the inductance of the choke in FIG. 6A and the slit width thereof.

FIG. 8 is graph showing the saturation characteristics of the choke in FIG. 6A and the choke in FIG. 1 for comparison.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

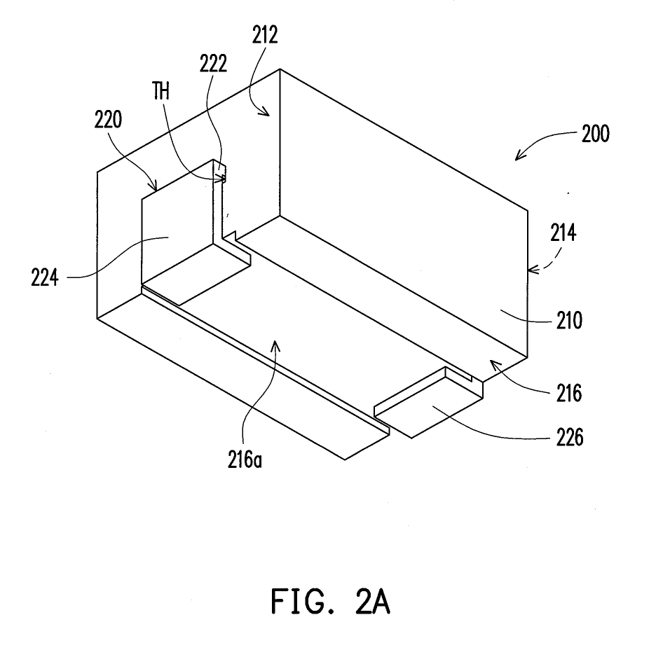

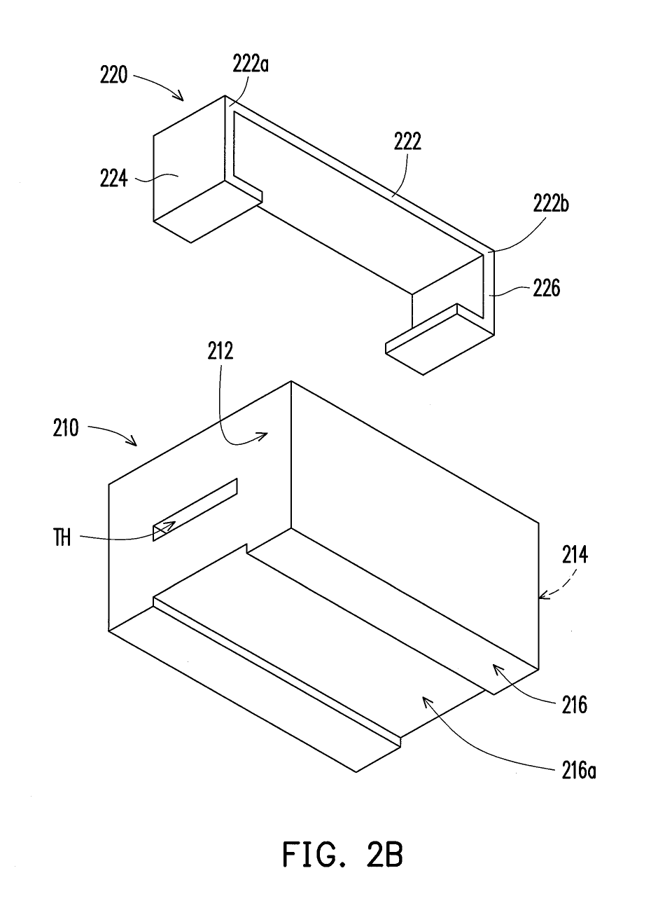

Referring to FIGS. 2A and 2B, a method for adjusting the inductance of the embodiment is suitable for adjusting the inductance of a choke 200. The choke 200 includes a core 210 and a conductive sheet 220. It should be noted that the conductive sheet 220 is an example of the embodiments only, which the present invention is not limited to. In other embodiments, for example, the quantity of the conductive sheet 220 can be a plurality and the conductive sheets 220 can be electrically independent from each other.

The core 210 is an integrated formed structure and fabricated, for example, by mold pressing a magnetic material, followed by sintering it at over 300° C. The core 210 is made of a magnetic material, which can be iron, sendust (iron-silicon-aluminium alloy), iron-nickel-molybdenum alloy, iron-nickel alloy, amorous alloy or ferrite; preferably, a material with magnetic permeability of 60-150 so as to have good saturation characteristic, for example, sendust, iron-nickel-molybdenum alloy, iron-nickel alloy or amorous alloy. The core 210 has a through hole TH passing through a first surface 212 and a second surface 214 opposite to the first surface 212 of the core 210. The core 210 can be cylinder, cuboid, cubic or hexagonal prism. In the embodiment, the core 210 is a cuboid, which the present invention is not limited to. The core 210 further has a recess 216a and has a third surface 216 connecting the first surface 212 and the second surface 214. The recess 216a is located correspondingly to the through hole TH and extends from the first surface 212 to the second surface 214. In other embodiments, the third surface 216 can have no recess (not shown for this option).

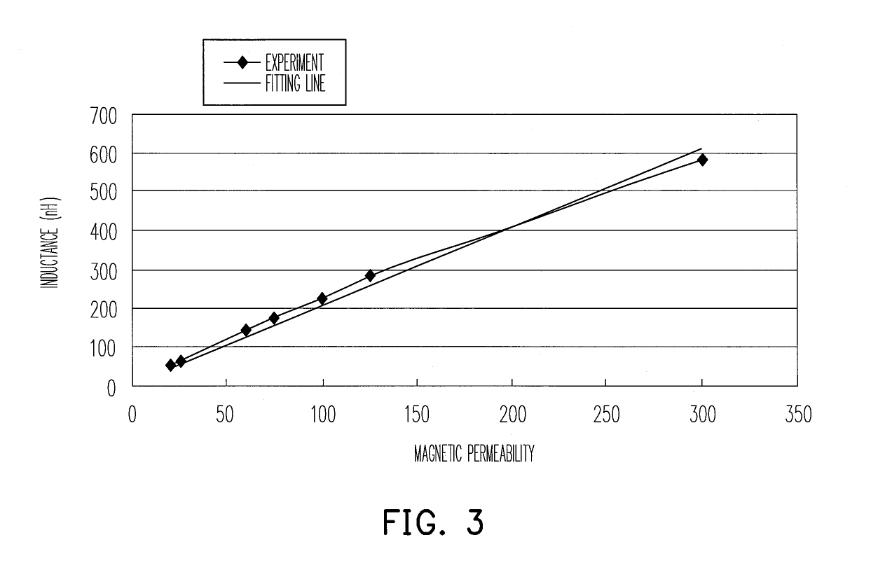

Referring to FIG. 3, when the dimensions of the core 210 are determined, a simulation can be conducted so as to obtain a relationship graph between the magnetic permeability of the magnetic material and the inductance of the choke 200, where the simulation result after a specific calculation indicates the relationship is approximately a straight line so that it suggests the magnetic permeability is directly proportional to the inductance substantially. It should be noted that FIG. 3 is an example of the embodiments only, which the present invention is not limited to. In more details, for a core with a certain size, there exists a corresponding straight linear relationship between the magnetic permeability and the inductance.

The conductive sheet 220 has a main-body portion 222 and two end portions 224 and 226 extending out respectively from both ends 222a and 222b of the main-body portion 222. The main-body portion 222 passes through the through hole TH and the two end portions 224 and 226 respectively extend along the first surface 212 and the second surface 214 to outside of the core 210. The two end portions 224 and 226 in the embodiment extend into the recess 216a of the third surface 216. The conductive sheet 220 is a material with good conductivity, for example, copper. The main-body portion 222 can be linear sheet or spiral sheet and the cross-section of the conductive sheet 220 can be rectangle or circle.

The method for adjusting the inductance provided by the embodiment is to adjust the magnetic permeability of the magnetic material composing the core 210 with an unchanged structure and unchanged dimensions of the core 210. It should be noted that the magnetic permeability can be adjusted by changing the kind of the magnetic material, that is, it can be adjusted by selecting a different kind of the magnetic material. The magnetic permeability can also be adjusted by adjusting the diameter of the powder particles of the magnetic material but the kind of the magnetic material is unchanged. The kind of a magnetic material is defined by both the same compositions contained in a magnetic material and the same proportions of each component thereof. In short, the required inductance is achieved by means of the positive correlation relationship between the magnetic permeability and the inductance.

In the embodiment, the method of changing the kind of the magnetic material includes selecting a magnetic material with higher or lower magnetic permeability, so that the choke 200 has higher or lower inductance. For example, for changing the composition of the material to adjust the magnetic permeability, ferrite, instead of iron, is selected; for changing the proportions of each component in the material to adjust the magnetic permeability, iron-nickel alloy with composition of 80% iron and 20% nickel, instead of iron-nickel alloy with composition of 90% iron and 10% nickel, is selected.

In the embodiment, the method of adjusting the diameter of the powder particles includes determining a kind of the magnetic material and the diameter of each single particle of the magnetic powder. Usually, magnetic permeability is directly proportional to the diameter of each single particle of the magnetic powder. The diameter of each single particle needs to be changed by adjusting the condition for sintering the powder (time, temperature and so on).

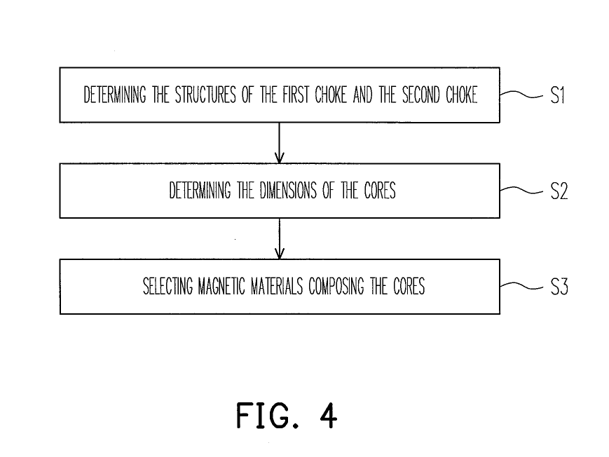

Based on the above-mentioned method for adjusting the inductance of the choke 200, a method for designing a choke with different inductance can be derived. Referring to FIG. 4, the method include: step S1, determining the structures of a first choke and a second choke; step S2, determining the dimensions of the core; step S3, selecting a magnetic material composing the core. In the step S1, the first and second chokes have the same structure. Each choke has a core 210 and a conductive sheet 220 (shown in FIGS. 2A and 2B).

The step S2 further includes determining the dimensions of the conductive sheet. The conductive sheet of the first choke and the conductive sheet of the second choke have the same dimensions, and the core of the first choke and the core of the second choke have the same dimensions.

In the step S3, the core of the first choke uses a first magnetic material with first magnetic permeability, the core of the second choke uses a second magnetic material with second magnetic permeability different from the first magnetic permeability. In the embodiment, the magnetic permeability can be changed by adjusting the diameter of each single particle of the magnetic powder. In more details, the material composition of a magnetic powder A is determined and then the diameter of each single particle of the magnetic powder A is determined. The magnetic powder A with the first diameter is termed as the first magnetic powder and the magnetic powder A with the second diameter is termed as the second magnetic powder. In other embodiments, the magnetic permeability can be changed by changing the kind of the magnetic material; i.e., the kinds of the magnetic materials composing the cores of the first and the second choke are determined, wherein a first kind magnetic powder is termed as the first magnetic material, a second kind magnetic powder is termed as the second magnetic material and the first kind magnetic powder is different from the second kind magnetic powder, which means the composition and the proportions of each component of the first kind magnetic powder are different from that of the second kind magnetic powder.

In the prior art, in order to adjust the inductance of a choke and design a choke with different inductance, the thickness of the employed resin pad is adjusted (i.e., adjusting the structure and the dimensions of a compound core structure). Different from the prior art, the embodiment adjusts the inductance by adjusting the magnetic permeability of the magnetic material and uses the core 210 with an integrated formed structure. As a result, it can avoid abnormal sound during the operation and allows to use a material with lower magnetic permeability (i.e., higher saturation characteristic) to fabricate the core so as to promote the saturation characteristic of the choke.

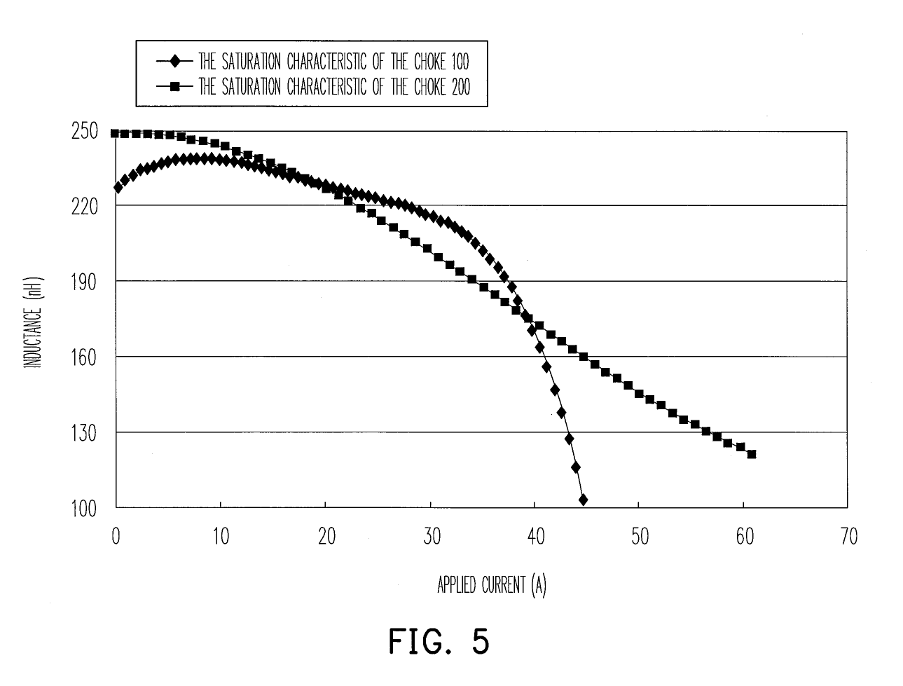

Some of experiment results are given to compare the saturation characteristic of the choke 200 with the conventional choke 100. It should be noted that the dimensions and the inductance of the choke 200 are similar to that of the choke 100, wherein the material of the choke 100 is ferrite with magnetic permeability of 1200 and the material of the choke 200 is sendust with magnetic permeability of 125. It can be seen from FIG. 5 that the decline speed of the inductance of the choke 200 along with increase of the applied current is less than that of the choke 100. In other words, the choke 200 has better saturation characteristic and a larger inductance than the choke 100 under the condition of the same applied currents greater than 40 A or so. Therefore, when the applied current is larger, the choke 200 can remain better inductance performance. The choke 200 has better saturation characteristic and can endure a larger current.

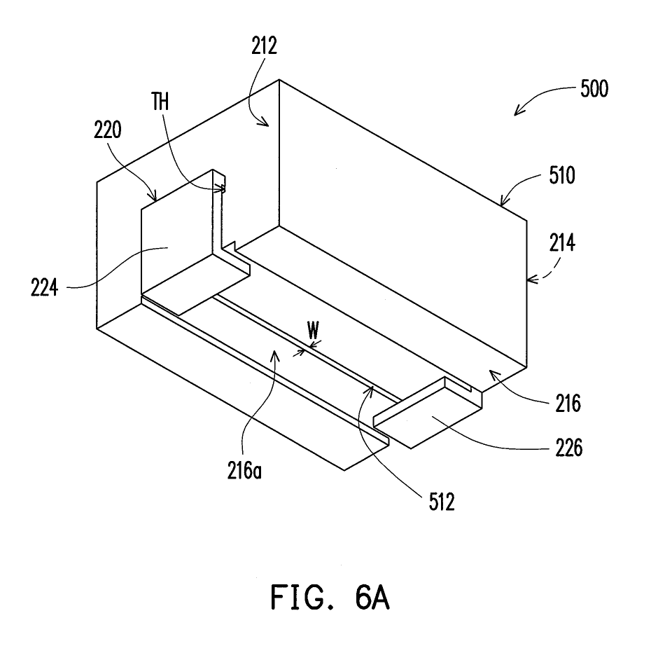

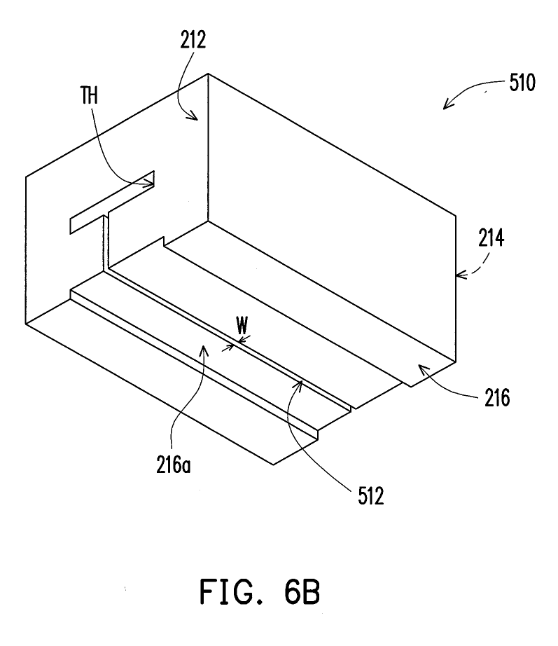

Referring to FIGS. 6A and 6B, the choke 500 of the embodiment has a structure similar to that of the choke 200 (the same parts or the similar part are denoted by the same marks) except that the core 510 of the choke 500 has an additional slit 512. The slit 512 is located on the bottom of the recess 216a of the third surface 216 and connects the recess 216a to the through hole TH. The method for adjusting the inductance includes adjusting the width W of the slit 512.

In the embodiment, the method of adjusting the width W of the slit 512 includes increasing or decreasing the width W of the slit 512 to reduce or increase the inductance of the choke 500.

In the embodiment, prior to adjusting the width W of the slit 512, the method as the embodiment of FIG. 2A can be used to adjust the kind of the magnetic material or the diameter of each single particle of the magnetic powder so as to adjust the magnetic permeability.

Different from the prior art, the embodiment adjusts the inductance by adjusting the width W of the slit 512 and the magnetic permeability, so that the method can avoid abnormal sound during the operation.

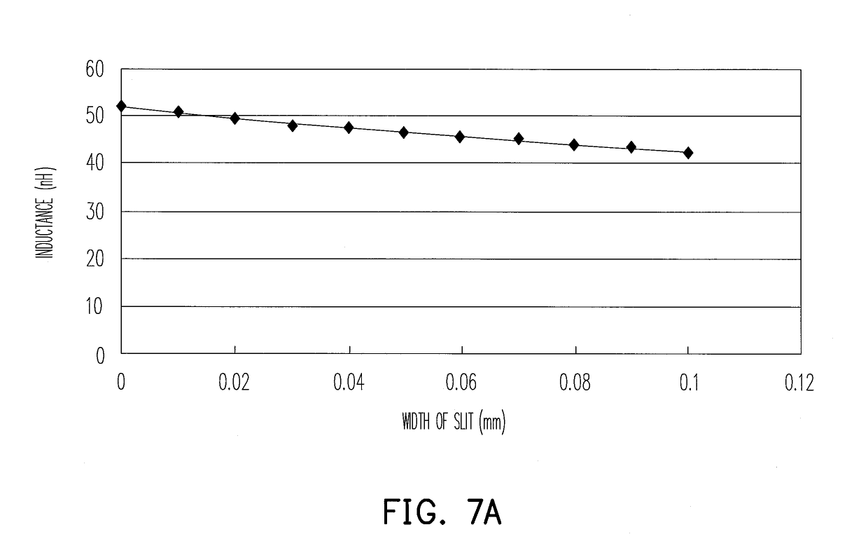

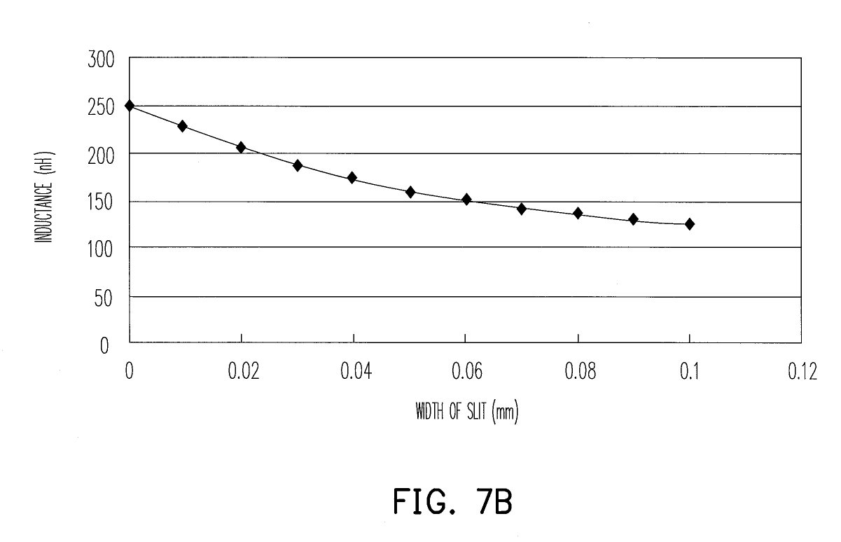

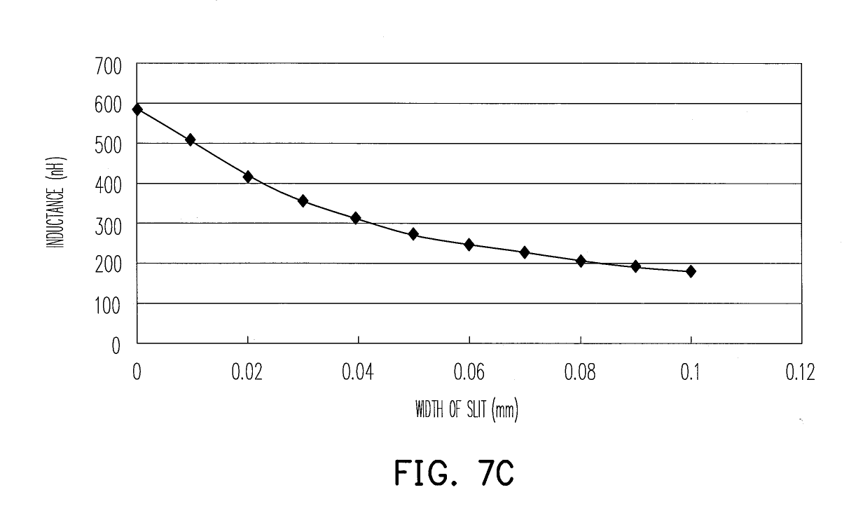

Referring to FIG. 7A, 7B and 7C, some experiment results illustrate the relationship between the inductance and the width W and the saturation characteristic, wherein the graphs of FIGS. 7A, 7B and 7C are corresponding to three cores of the choke respectively having magnetic permeabilities of 20, 125 and 300, respectively, and the cores are made of sendust. It can be seen from FIGS. 7A, 7B and 7C that the inductance of the choke 500 is declined with the increase of the width W of the slit 512. In other words, the inductance is negative correlated to the width W. Therefore, the embodiment can adjust the inductance by adjusting the width W of the slit 512. In addition, the inductance can be affected by the magnetic permeability as well. In particular, when the width W of the slit 512 of the core 510 is unchanged and the core 510 is made of a magnetic material with higher magnetic permeability, the choke 500 has higher inductance. In other words, the inductance is positive correlated to the magnetic permeability.

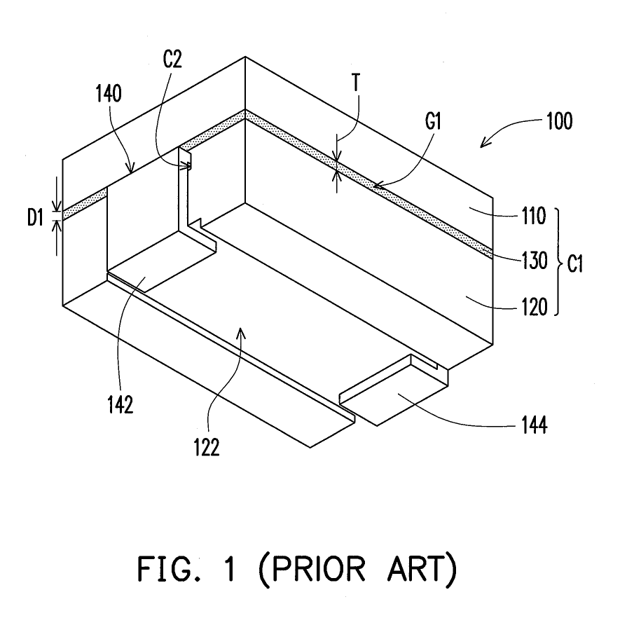

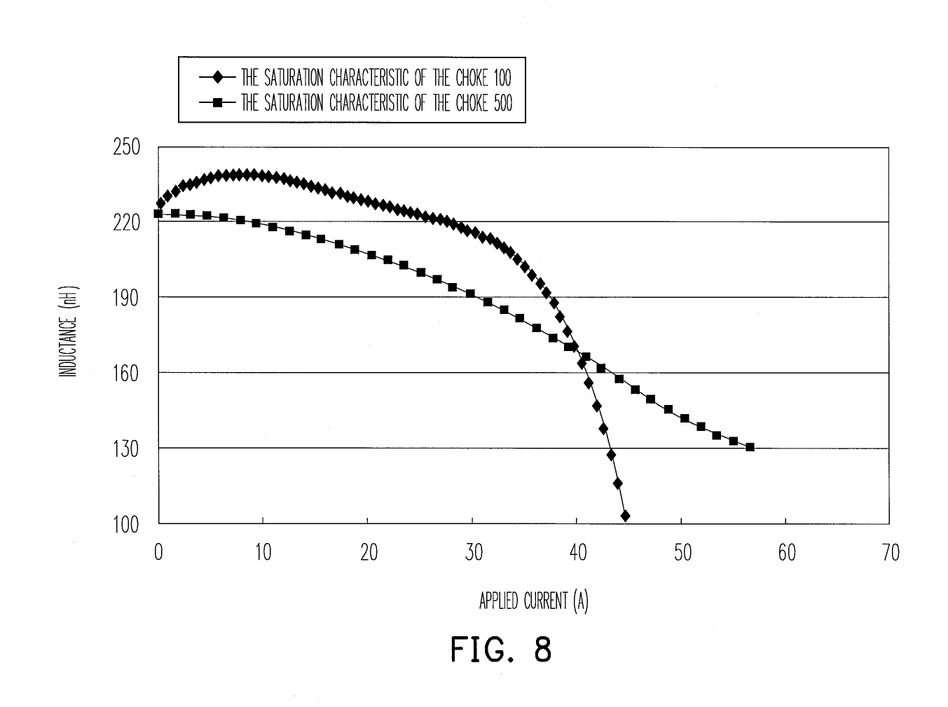

In the embodiment, the dimensions and the inductance of the choke 500 in FIG. 6A are similar to that of the choke 100 in FIG. 1, the choke 100 is made of ferrite with magnetic permeability of 1200, and the choke 500 is made of sendust with magnetic permeability of 125. It can be seen from FIG. 8 that the decline speed of the inductance of the choke 500 of the embodiment along with the increase of the applied current is less than that of the conventional choke 100. In other words, the choke 500 has better saturation characteristic. In addition, when the applied current is greater than 40 A or so the choke 500 has a larger inductance than that of the choke 100 under the condition of the same applied currents. Therefore, when the applied current is larger, the choke 500 can remain better inductance performance.

In short, by using the method for adjusting the inductance of the choke 500 of the embodiment, the choke 500 has better saturation characteristic and can endure a larger current.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for adjusting the inductance of a choke, wherein the choke comprises a core and at least a conductive sheet, the core is an integrated formed structure and has a through hole passing through a first surface and a second surface opposite to the first surface of the core, the conductive sheet has a main-body portion and two end portions respectively extending from both ends of the main-body portion, the main-body portion passes through the through hole and the two end portions respectively extend along the first surface and the second surface to outside of the core; the method for adjusting the inductance comprising:
with an unchanged structure and unchanged dimensions of the core, adjusting the magnetic permeability of the magnetic material composing the core.

2. The method as claimed in claim 1, wherein adjusting the magnetic permeability comprises changing the kind of the magnetic material composing the core.

3. The method as claimed in claim 1, wherein adjusting the magnetic permeability further comprises adjusting the diameter of the powder particles of the magnetic material composing the core.

4. The method as claimed in claim 1, wherein the magnetic permeability is positive correlated to the inductance of the choke.

5. The method as claimed in claim 1, further comprising adjusting the width of a slit of the core, wherein the slit connecting the through hole.

6. The method as claimed in claim 5, wherein the adjusting the width of the slit comprises:
increasing the width of the slit for reducing the inductance of the choke or decreasing the width of the slit for increasing the inductance of the choke.

7. The method as claimed in claim 5, wherein the width of the slit is negative correlated to the inductance of the choke.

8. A method for designing a choke, comprising following steps:
determining the structures of a first choke and a second choke, wherein the first choke and the second choke have the same structures and each choke has a core;
determining the dimensions of the cores, wherein the cores have the dimensions same as each other; and
selecting magnetic materials composing the cores, wherein the core of the first choke uses a first magnetic material with first magnetic permeability, the core of the second choke uses a second magnetic material with second magnetic permeability and the first magnetic permeability is different from the second magnetic permeability.

9. The method as claimed in claim 8, wherein in the step of determining the structures of a first choke and a second choke, each core is an integrated formed structure and has a through hole, each choke further has a conductive sheet, the conductive sheet has a main-body portion and two end portions respectively extending from both ends of the main-body portion, and the main-body portion passes through the through hole.

10. The method as claimed in claim 9, wherein the step of determining the dimensions of the cores further comprises determining the dimensions of the conductive sheets, wherein the conductive sheets have the dimensions same as each other.

11. The method as claimed in claim 8, wherein the step of selecting magnetic materials composing the cores further comprises:
determining the kind of a magnetic powder; and
determining the diameter of each single particle of the magnetic powder, wherein the magnetic powder with a first diameter is the first magnetic material and the magnetic powder with a second diameter is the second magnetic material.

12. The method as claimed in claim 8, wherein the step of selecting magnetic materials composing the cores further comprises:
determining the kinds of the magnetic materials composing the cores, wherein a first kind magnetic powder is the first magnetic material and a second kind magnetic powder different from the first kind magnetic powder is the second magnetic material.

13. A choke, comprising:
a core, wherein the core is an integrated formed structure and has a through hole, the through hole passes through a first surface and a second surface opposite to the first surface of the core; and
at least a conductive sheet, wherein the conductive sheet has a main-body portion and two end portions respectively extending from both ends of the main-body portion, the main-body portion passes through the through hole and the two end portions respectively extend along the first surface and the second surface to outside of the core.

14. The choke as claimed in claim 13, wherein the core has a slit connecting the through hole.

15. The choke as claimed in claim 14, wherein the core has a third surface connecting the first surface and the second surface, and the slit is located on the third surface.

16. The choke as claimed in claim 15, wherein the third surface of the core has a recess, the recess extends from the first surface to the second surface, the slit is located on the bottom of the recess of the third surface and connects the recess to the through hole, and the two end portions of the conductive sheet extend into the recess of the third surface.

17. The choke as claimed in claim 13, wherein the core is composed of a magnetic material and the magnetic permeability of the magnetic material is 60 to 150.

18. The choke as claimed in claim 17, wherein the magnetic material comprises iron-silicon-aluminium alloy, iron-nickel-molybdenum alloy, iron-nickel alloy or amorous alloy.
